(19) United States
(12) Patent Application Publication
(10) Pub. No.: US 2005/0154613 A1
(43) Pub. Date: Jul. 14, 2005

(54) System and method for creation of operative notes for use in surgical facilities

(76) Inventor: Christopher S. Kade, Effingham, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/755,991

(22) Filed: Jan. 13, 2004

(51) Int. Cl. G06F 17/60

(52) U.S. Cl. 705/2

(57) ABSTRACT

Disclosed is a computer program and method of generating operative notes by a surgeon after a surgical procedure. The software and method include the steps of 1) displaying a list of patient cases for which operative notes need to be created, 2) displaying a procedure performed for one of the patient cases, 3) displaying a list of sections for an operative note and text that comprises a selected section from of the list of sections of the operative note, 4) inserting predetermined text into the operative note having indicia indicating where the surgeon must modify the operative note to include information specific to the patient upon which the surgical procedure has been performed, and 5) providing means for successively identifying the indicia where text must be inserted into the operative note.

### FIELD OF THE INVENTION

The present invention relates to a system and method for creating operative notes detailing a surgical operation that has been performed.

### BACKGROUND OF THE INVENTION

Operative notes are statements that detail a procedure performed by a surgeon. Generally, the operative note is very comprehensive and identifies all procedures performed by the surgeon. Operative notes are necessary for both the purpose of record keeping and for billing of insurance providers. Therefore, the quicker the operative notes are completed, the quicker the insurance carrier can be billed for the services provided by a surgeon and surgery center.

Particularly for ambulatory surgery centers, a surgeon normally performs a limited set of procedures numerous times. As such, the operative notes for the procedures do not vary substantially from patient to patient. Many times only a few items of text within the operative note are unique to the patient upon which the surgical procedure was performed.

In the past, surgeons have dictated operative notes detailing the surgical procedures performed. As a result, the surgeon or surgical center was required to hire or outsource the services of a transcriptionist to produce an operative report from a surgeon's recorded dictation, an option which can run into thousands or tens of thousands of dollars annually for even a small-sized facility.

Another difficulty with generating operative notes is that each surgeon will have his or her own preferred text that is entered into the operative note. As such, different surgeons do not use the same text for their operative notes. Therefore, any solution to minimize the expense of generating operative notes must take this fact into account.

Another difficulty with generating operative notes is complying with the strict privacy laws concerning patient information. These privacy laws prevent disclosure of confidential medical information to third parties. Because non-treating physicians are third parties for the purposes of privacy laws, physicians must be prevented from viewing patient information for other physicians' patients.

### SUMMARY OF THE INVENTION

The present invention generally comprises a computer program and method of generating operative notes by a surgeon after a surgical procedure. The software and method include the steps of displaying a list of patient cases for which operative notes need to be created, displaying a procedure performed for one of the patient cases, displaying a list of sections for an operative note and text that comprises a selected section of the list of sections of the operative note, inserting predetermined text into the operative note having indicia indicating where the surgeon must modify the operative note to include information specific to the patient upon which the surgical procedure has been performed, and providing means for successively identifying the indicia where text must be inserted into the operative note.

### BRIEF DESCRIPTION OF THE DRAWINGS

FIG. 1 is a view of the main screen according to an embodiment of the present invention;

FIG. 2 is a view of the template screen according to an embodiment of the present invention;

FIG. 3 is a view of the template edit screen according to an embodiment of the present invention;

FIG. 4 is a view of the cases without operative notes screen according to an embodiment of the present invention;

FIG. 5 is a view of the create operative note screen according to an embodiment of the present invention;

FIG. 6 is a view of the apply template screen according to an embodiment of the present invention;

FIG. 7 is a view of the view and print operative note screen according to an embodiment of the present invention; and

FIG. 8 is a view of the actions screen according to an embodiment of the present invention.

### DESCRIPTION OF THE PREFERRED EMBODIMENT

While the invention is susceptible of embodiment in many different forms, there is described in detail preferred embodiments of the invention. It is to be understood that the present disclosure is to be considered only as an example of the principles of the invention. This disclosure is not intended to limit the broad aspect of the invention to the illustrated embodiments. The scope of protection should only be limited by the claims.

The preferred embodiment of the present invention comprises a computer program intended for use in a surgical facility setting. Its purpose is to enable surgeons to quickly produce and print their operative notes immediately after conclusion of a surgical procedure. The surgeon's operative notes comprise the key document required for insurance billing and, therefore, producing it efficiently has a direct benefit to efficiency of operation for the surgeon and the facility. The source code of the software application of the preferred embodiment is written as a Windows Forms application for Windows 32-bit operating systems with the Microsoft Visual Basic NET software development package available from Microsoft, Inc. of Redmond, Wash. However, one of ordinary skill in the art would recognize that the concepts of the present invention apply to any software development package intended for use with any computer operating system.

Preferably, the present invention operates in conjunction with a database that contains information regarding each patient and operative procedure that is performed. The preferred embodiment of the present invention operates in conjunction with a SQL database and SOURCE MEDICAL ADVANTX SURGERY CENTER surgery center management software available from Source Medical, Inc. of Birmingham, Ala. Such surgery center management software is responsible for storing information relating to patient scheduling, patient case history, facility inventory, facility personnel, reports, patient billing and case costing within the SQL database. However, it will be readily understood by one of ordinary skill in the art that the present invention, rather than being a stand-alone program used in conjunction with an existing database and facility management software, could incorporate the above functions to provide a single software program capable of complete facility management. Additionally, other database technologies could be employed rather than SQL and Source Medical AdvantX Surgery Center.

Provided below is a description of the operation of the preferred embodiment of the present invention. It will be clear to a programmer of ordinary skill in the art how to create a software program according to the operation described below.

Because the present invention manages patient medical information, to access the software of the present embodiment, the system of the preferred embodiment requires a user to provide a usemame and password in order to gain access. The software checks the user's username and password against stored usernames and passwords of authorized users and allows the user to access the software if the username/password combination is valid. The user's ability to access patient information is restricted based upon the rights associated with the user's username. If the username has the rights of a treating physician, the physician may only see patient cases (described further below) associated with the physician and cannot see patient cases that are not associated with the treating physician. However, if the username has the rights of a billing administrator, the billing administrator may see patient cases associated with any patient.

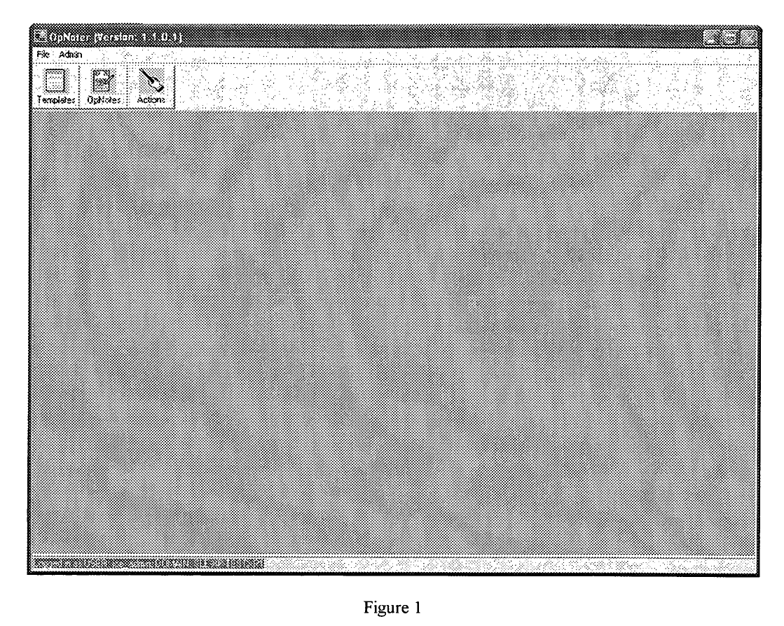

Next, referring to FIG. 1, upon successful entry of a usemame and password, a main menu appears on the computer display. The main menu comprises a button bar that has three possible actions for the surgeon to access. The three possible actions represented by the buttons are: Templates, OpNotes and Actions.

In addition to buttons, the main menu also contains File and Admin pulldown menus. The File menu enables a user to exit the application. The Admin menu is intended to provide access to various application administration functions. The only function currently available under this menu is a “table load” procedure that enables a user to manually copy data from the surgery center's management application into the software program's SQL database.

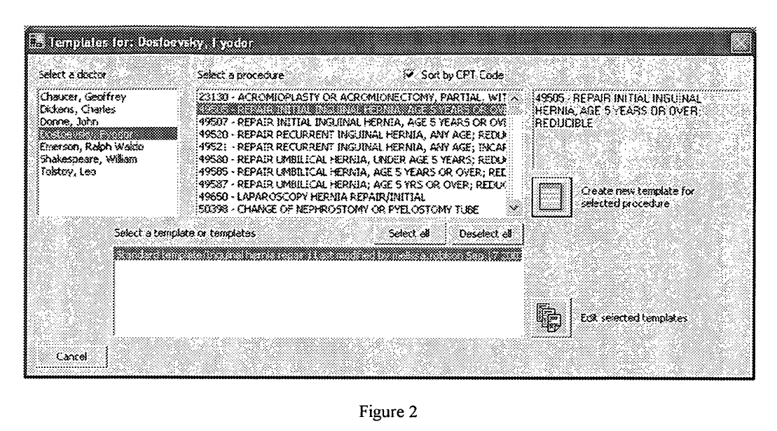

By selecting the Templates action, the screen of FIG. 2 appears. The Templates screen enables a surgery center staff person to select a given credentialed surgeon in a first window. After selecting the credentialed surgeon, the software queries the database to determine the procedures that the surgeon is authorized to perform at the facility. The authorized procedures are displayed in a second window. By next selecting a procedure in the second window, the software queries the database to determine whether any template for an operative note exists for the selected procedure and the selected surgeon. If so, a description of the template(s) appears in a third window. The surgery center staff may select one of the existing templates to make edits to the template or may create a new template for use and storage within the database for later recall.

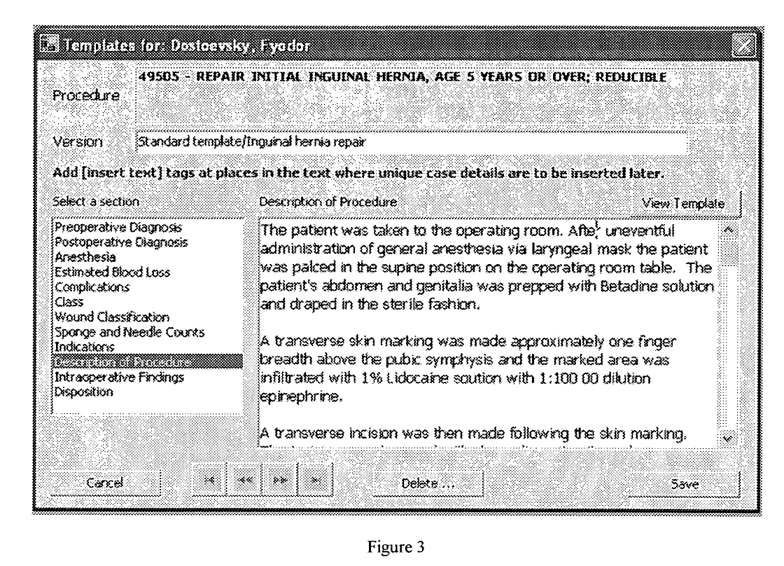

By choosing to either edit an existing template or create a new template, the screen of FIG. 3 will appear. The screen of FIG. 3 shows the procedure name for which the template is being created and a template name. The surgery center staff person then selects a section of the operative note and enters or modifies the text within that section of the note. After entering or modifying the text, the surgery center staff person may choose to cancel the changes made, save the changes made or delete the template entirely. The arrow keys enable a user to navigate among templates if more than one template was selected in the previous screen.

The concept of utilizing templates for operative notes is that, particularly for the types of procedures performed at ambulatory surgery centers, an operative note for a particular surgeon and procedure will employ nearly identical wording every time it is produced. To accommodate those few areas of an operative note that will require some unique text dealing with a particular patient, the surgeon will enter indicia indicating that an item of information unique to the patient upon which the surgical procedure has been performed must be entered, specifically the bracketed phrase “[insert text]”, which will enable the program's logic to quickly locate for the surgeon those areas that must be modified when creating a new operative note from a template. Other types of indicia may be used to bring the surgeon's attention to the portion of text that is unique to a particular patient.

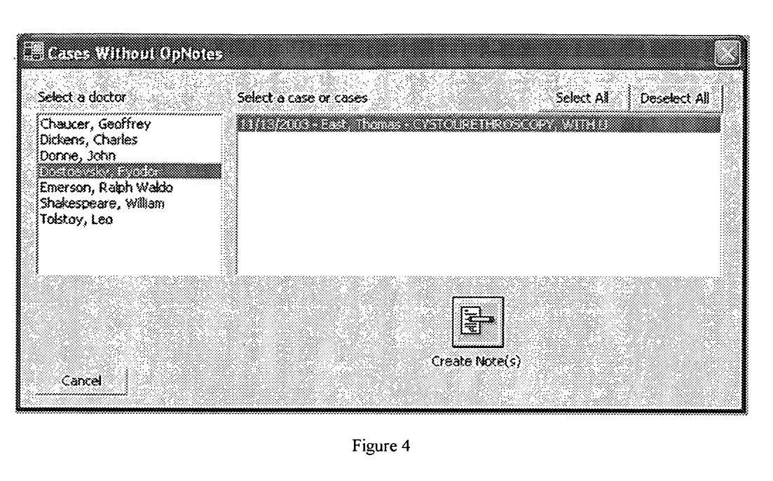

The surgeon's interaction with the program of the present embodiment begins with the OpNotes button on the main menu toolbar. When the surgeon clicks the OpNotes button, the surgeon is presented with the screen of FIG. 4. The screen of FIG. 4 displays two sections. The first section displays only the name of the surgeon entering the operative note. The second section is populated after a doctor has been selected in the first section and shows a list of patient cases for which operative notes need to be created. This list of cases is created by accessing the database to determine all procedures recently performed (or scheduled to be performed) by the surgeon and then determining whether an operative note has been completed for that case. The surgeon may select a single case or all cases and choose the create notes button. In the alternative, the first window could list all surgeons authorized to perform surgical procedures at the facility. In this case the second window would only populate with patient cases when the surgeon clicked upon his own name in the first window.

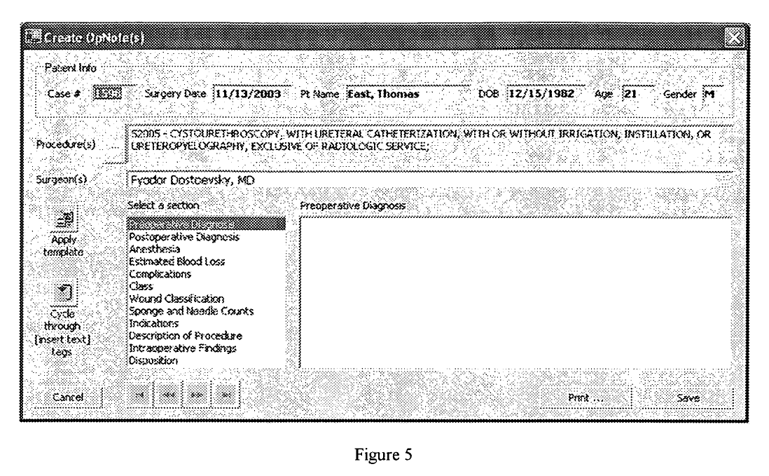

Upon choosing the create notes button, the surgeon is shown the screen of FIG. 5. The screen of FIG. 5 displays relevant information about the patient, such as case number, surgery date, name, birth date, age and gender. This information cannot be edited by the surgeon. Also displayed is the name of the procedure performed upon the patient and the name of the surgeon performing the procedure. The surgeon may edit the procedure(s) performed and the name of the surgeon performing the procedure.

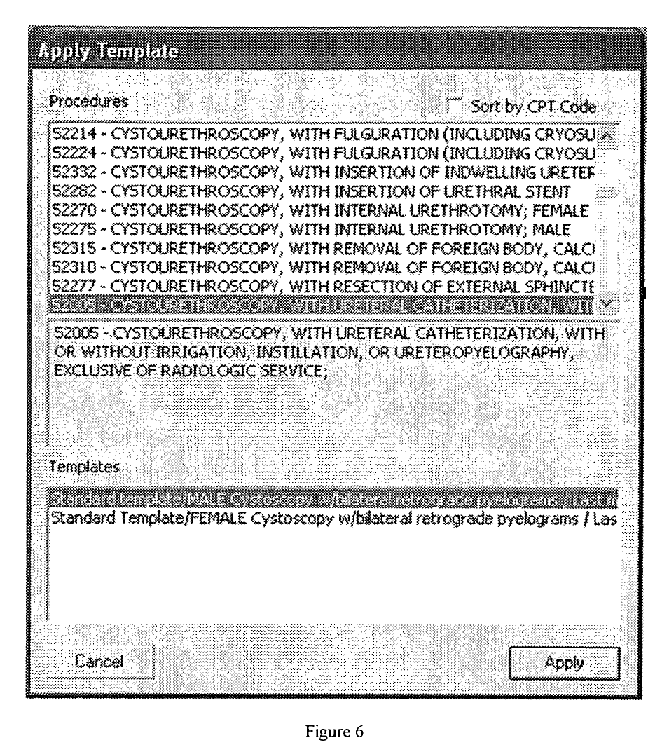

Next, the surgeon chooses the apply template button and the screen of FIG. 6 is displayed. The procedures portion of the screen is automatically scrolled to the particular procedure specified in the previous screen. The templates portion of the screen displays the templates which are associated with the procedure selected in the procedures portion. The surgeon then chooses the template to be used for the operative note.

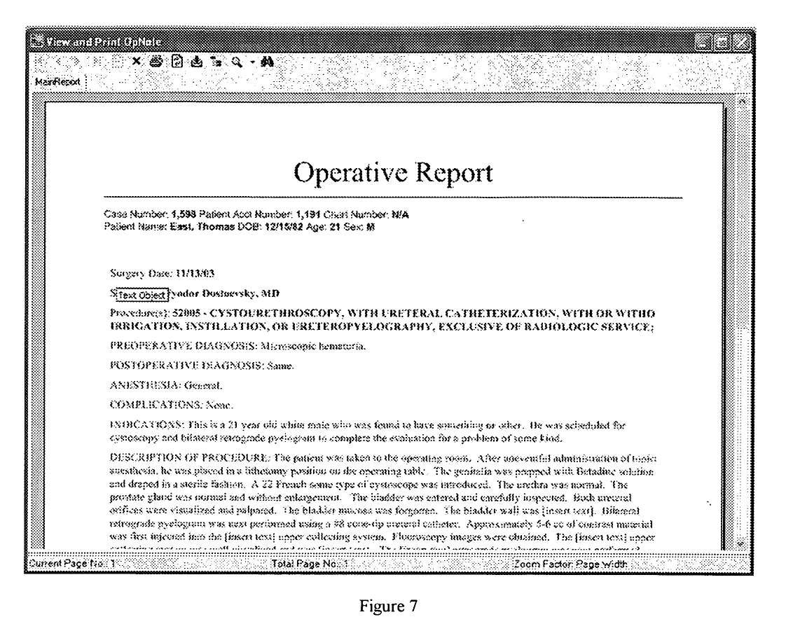

When the surgeon makes the selection, an operative note is generated with the text that has been previously keyed and stored by staff (FIG. 5). Then, simply by clicking the cycle button, the surgeon can locate the indicia indicating the position where text unique to the patient upon which the procedure has been performed must be positioned and modify the area of the operative note. When the surgeon is finished reviewing the operative note and entering unique text regarding the operation, the surgeon clicks the save button and chooses to print the operative note. The surgeon is then shown a preview of an Operative Report for the surgeon's review (FIG. 7). After printing, the surgeon has to sign the resulting printout and deliver it to a surgical center staff person for further processing, such as maintaining separate records of the operative note for the purposes of billing records and for placement in the patient's medical file.

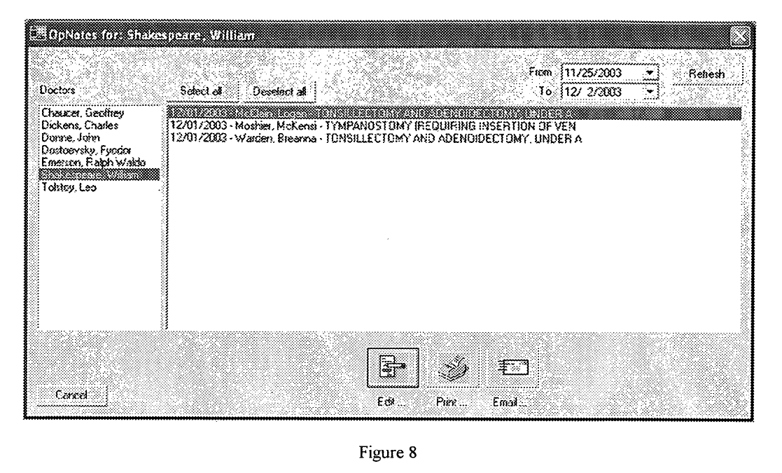

The final main menu item (FIG. 1) is the Actions button. By selecting the Actions button, the software provides to surgical center staff personnel a screen enabling the capability to edit, print and email the operative notes that have been completed by the surgeon and stored in the database, as shown in FIG. 8.

While the specific embodiments have been described, numerous modifications come to mind without significantly departing from the spirit of the invention, and the scope of protection should only limited by the scope of the accompanying claims.

1. A method of generating operative notes by a surgeon after a surgical procedure comprising:
displaying a list of patient cases for which operative notes need to be created;
displaying a procedure performed for one of the patient cases;
displaying a list of sections for an operative note and text that comprises a selected section from of the list of sections of the operative note;
inserting predetermined text into the operative note having indicia indicating where the surgeon must modify the operative note to include information specific to the patient upon which the surgical procedure has been performed; and
providing means for successively identifying the indicia where text must be inserted into the operative note.

2. The method of claim 1 further comprising the steps of:
displaying a list of surgeons authorized to prepare operative notes; and
wherein the step of displaying a list of patient cases for which operative notes need to be created is performed in response to the selection of a particular surgeon from the list of surgeons authorized to prepare operative notes

3. The method of claim 1 wherein information comprising the list of patient cases for which operative notes need to be created and the procedure performed for the patient case are obtained from a database created by a separate software package.

4. The method of claim 1 wherein the list of patient cases is created by accessing a database to determine all procedures recently performed and then determining whether an operative note has already been completed for that patient case.

5. The method of claim 1 wherein the predetermined text inserted into the operative note comprises text unique to the particular surgeon and the procedure performed for the patient case.

6. The method of claim 1 wherein only one section selected from the list of sections of the operative note is displayed at a time.

7. The method of claim 1 further comprising the step of selecting the predetermined text to be inserted from a list of different predetermined texts.

8. The method of claim 1 further comprising the step of allowing the surgeon to select and modify the procedure performed in the patient case.

9. The method of claim 1 further comprising the step of confirming the identity of the surgeon; and
wherein the step of displaying a list of patient cases for which operative notes need to be created comprises displaying a list of patient cases associated with the surgeon for which operative notes need to be created.

10. Computer software for entering operative notes by a surgeon after a surgical procedure performing the steps of:
displaying a list of surgeons authorized to prepare operative notes; and
displaying a list of patient cases for which operative notes need to be created in response to the selection of a particular surgeon from the list of surgeons authorized to prepare operative notes;
displaying a procedure performed for the patient case;
displaying a list of sections for an operative note and text that comprises a selected section from of the list of sections of the operative note;
providing means for the surgeon to select a section of the operative note to view that section of the operative note;
inserting predetermined text into the operative note having indicia indicating where text must be inserted into the predetermined text to customize the operative note to the patient upon which the surgical procedure has been performed; and
providing means for successively identifying the indicia where text must be inserted into the operative note.

11. The software of claim 10 wherein information comprising the list of patient cases for which operative notes need to be created and the procedure performed for the patient case are obtained from a database created by a separate software package.

12. The software of claim 10 wherein the list of patient cases is created by accessing a database to determine all procedures recently performed and then determining whether an operative note has already been completed for that patient case.

13. The software of claim 10 wherein the predetermined text inserted into the operative note comprises text unique to the particular surgeon and the procedure performed.

14. The software of claim 10 wherein only one section selected from the list of sections of the operative note is displayed at a time.

15. The software of claim 10 further comprising the step of selecting the predetermined text to be inserted from a list of different predetermined texts.

16. The software of claim 10 further comprising the step of confirming the identity of the surgeon; and
wherein the step of displaying a list of patient cases for which operative notes need to be created comprises displaying a list of patient cases associated with the surgeon for which operative notes need to be created.

17. A system for creating operative notes by surgeons after performing a medical procedure comprising:
a database of predetermined text containing operative notes for a plurality of surgeons and a plurality of procedures, the database comprising a plurality of records, each record comprising a separate operative note for a particular procedure and having at least one surgeon associated with each operative note, and wherein each operative note comprises indicia for indicating where the operative note must be modified to customize the operative note to a particular patient upon which the procedure was performed;
means for displaying a list of patient cases for which operative notes need to be created;
means for selecting a patient case from the list of patient cases;
means for selecting a particular operative note from the database of operative notes;
means for successively directing the surgeon to the indicia of the operative note indicating where the operative note must be modified;
means for editing the selected operative note to insert text into the predetermined text to customize the operative note to the patient upon which the procedure was performed.

18. The computer software of claim 17 wherein the means for selecting a particular operative note from the database of operative notes is performed automatically based upon the surgeon performing the procedure and the procedure performed.

19. The computer software of claim 18 comprising:
means for displaying a list of sections for an operative note; and
wherein the means for editing the selected operative note to insert text into the predetermined text to customize the operative note to the patient upon which the procedure was performed displays allows editing of only a section from the list of sections that has been selected from the list.

20. The computer software of claim 19 further comprising:
means displaying a list of surgeons authorized to prepare operative notes; and
wherein the means for displaying a list of patient cases for which operative notes need to be created operates in response to the selection of a particular surgeon from the list of surgeons authorized to prepare operative notes

21. The computer software of claim 20 wherein information comprising the list of patient cases for which operative notes need to be created and the procedure performed for the patient case are obtained from a database created by a separate software package.

22. The computer software of claim 17 wherein the means for selecting a particular operative note from the database of operative notes is performed manually by the surgeon by selecting an operative note from a list of operative notes.

23. The computer software of claim 17 further comprising the step of confirming the identity of the surgeon; and
wherein the step of displaying a list of patient cases for which operative notes need to be created comprises displaying a list of patient cases associated with the surgeon for which operative notes need to be created.
